(19) United States
(12) Patent Application Publication
(10) Pub. No.: US 2026/0244830 A1
(43) Pub. Date: Aug. 20, 2026

(54) Method for Providing a Representation of a Free Space in an Environment of a Technical System

(71) Applicant: Robert Bosch GmbH, Stuttgart (DE)

(72) Inventors: Simon Roesler, Hildesheim (DE); Oliver Lange, Hemmingen (DE)

(21) Appl. No.: 19/543,196

(22) Filed: Feb. 18, 2026

(30) Foreign Application Priority Data
Feb. 20, 2025 (DE) 10 2025 106 518.7

(51) Int. Cl. G06F 30/27; G06F 111/18

(52) U.S. Cl. CPC G06F 30/27; G06F 2111/18

(57) ABSTRACT

A method for providing a representation of a free space in an environment of a technical system is disclosed. Also, a computer program, a device, and a storage medium for this purpose is also disclosed.

This application claims priority under 35 U.S.C. § 119 to patent application no. DE 10 2025 106 518.7, filed on Feb. 20, 2025 in Germany, the disclosure of which is incorporated herein by reference in its entirety.

The disclosure relates to a method for providing a representation of a free space in an environment of a technical system. The disclosure further relates to a computer program, a device, and a storage medium for this purpose.

### BACKGROUND

Various prior art approaches use methods based on machine learning models such as neural networks to determine free space, which perform convolutions in space from a bird's eye view (BEV). Sensor data such as camera images, radar or lidar scans are encoded in a feature space of the bird's-eye view representation, and finally, a classification is performed for each cell of the bird's-eye view representation to determine free cells. The desired resolution is therefore directly linked to the resolution of the bird's-eye view. The computing and memory consumption for the features of the bird's-eye view thus scales quadratically with the resolution in particular.

One example of bird's-eye view-based prediction of free space is Lift-Splat-Shoot, which enables the detection of drivable surfaces in BEV space. Another example is NVRadarNet, which detects drivable surfaces in BEV space using radar scans.

In addition, there are sparse approaches for 3D occupancy prediction that attempt to reduce computing requirements.

### SUMMARY

The subject matter of the disclosure is a method, a computer program, a device, and a computer-readable storage medium having the features set forth below. Further features and details of the disclosure result from the respective subject matter set forth in the description and the drawings. Features and details which are described in connection with the method according to the disclosure naturally also apply in connection with the computer program according to the disclosure, the device according to the disclosure, and the computer-readable storage medium according to the disclosure, and vice versa in each case, so that a reciprocal reference is always possible with regard to the disclosure.

The subject matter of the disclosure is, in particular, a method for providing a representation of a free space in an environment of a technical system, comprising:
providing sensor data, wherein the sensor data results from a detection by at least one sensor of the technical system, for example a camera, radar, lidar, infrared, and/or ultrasonic sensor,
extracting features from the sensor data to provide a feature map of the technical system's environment,
projecting virtual beams into the provided sensor data, for example into individual images if the sensor data is image data, wherein a common origin starting from the technical system and a respective beam direction are specified for the virtual beams to be projected or projected,
scanning individual positions along the projected virtual beams, wherein extracted features of the provided feature map are determined at each of the scanned individual positions, i.e., in particular, a position is determined at which initially extracted features are present that represent, for example, an object, in order to be able to determine a distance to this object.
determining or predicting a length value for each projected virtual beam based on a result of the scanning, wherein the result of the scanning is, for example, the determined positions at which features extracted first along a virtual beam are present, so that the length value corresponds in particular to the distance from the technical system to the object represented in the extracted features,
providing or predicting the representation of the free space based on the specified common origin, the specified beam direction, and the determined length values of the projected virtual beams.

The method according to the disclosure can thus advantageously provide a precise representation of the free space in the environment of the technical system. The method according to the disclosure can be carried out using a machine learning model, in particular a trained machine learning model. The machine learning model can learn to extract the features and/or predict the length values and/or predict the representation of the free space as part of appropriate training.

The features can thus be extracted from the sensor data using a machine learning model, in particular a trained machine learning model that has been trained to extract relevant patterns and structures from the sensor data. The sensor data can first be processed in a suitable form, for example by normalization or transformation. The machine learning model can then be trained to extract meaningful features from the sensor data. The machine learning model can be, for example, a convolutional neural network (CNN), which can be used to identify or extract hierarchical features such as edges, textures, or objects from complex data types such as images or point clouds.

In another embodiment, the method may further comprise:
transferring the provided sensor data into a bird's-eye view representation,
   wherein, in the context of projection, the virtual beams are projected into the bird's-eye view. This makes it possible to provide a simplified representation of the free space. The bird's-eye view offers an intuitive perspective on the technical system's environment and can facilitate interpretation.

A further advantage can be achieved within the scope of the disclosure if the method further comprises:
providing further sensor data, wherein the further sensor data results from detection by at least one further sensor of the technical system, for example a camera, radar, lidar, infrared, and/or ultrasonic sensor, wherein the at least one further sensor corresponds to a different sensor modality than the at least one sensor,
extracting features from the additional sensor data, which is performed in particular in a manner analogous to the sensor data,
merging the extracted features from the additional sensor data with the extracted features from the sensor data to provide the feature map of the environment of the technical system.

This can increase the accuracy of the representation of the free space, as additional information from different perspectives and/or sensor modalities is integrated. This leads in particular to a more comprehensive and detailed representation of the environment, which can provide a better basis for navigation and obstacle avoidance.

The disclosure may provide for the scanning of the individual positions to take place at regular and/or random intervals and/or at intervals determined within the framework of machine learning along the virtual beams. The uniform or random intervals enable detailed detection of the environmental features. Machine learning can be used to determine the optimal distance distribution for a given situation.

In another embodiment, the method may further comprise:
predicting a height and/or semantic class of objects such as other vehicles, pedestrians, or road boundaries in the environment of the technical system based on the provided feature map or the extracted features.
wherein, in the context of the representation of the free space, the predicted height and/or the semantic class of the objects in the environment of the technical system is also specified. The semantic class can, for example, specify a type of a respective object such as “trafficable surface,” “other vehicle,” “pedestrian,” or “road boundary,” wherein it can also be specified whether a respective object is static or dynamic. The height and/or semantic class of the objects specified in the representation of the free space enables a detailed and informative visualization of the environment, which allows, for example, a more differentiated trajectory to be planned.

It may be provided within the scope of the disclosure that the representation of the free space represents the free space in the form of a polygon, wherein corner points of the polygon correspond to end points of the projected virtual beams. The end points are, in particular, points that lie at a distance from the origin that corresponds to the specified length value of the virtual beams. The end points are therefore located in particular at a point where, starting from the origin, there is a first object such as another vehicle, a pedestrian, or a road boundary. This has the advantage that the free space can be clearly and precisely represented as a geometric object, which can be helpful, for example, for navigation and planning the movements of the technical system. In addition, this enables, in particular, easy transfer and processing of the representation of the free space to or by other systems.

Optionally, the technical system may be a vehicle or a mobile robot. The method according to the disclosure can therefore be used, for example, in the context of navigation, trajectory planning, and/or obstacle avoidance in vehicles or mobile robots.

It is possible for the method according to the disclosure to be used in a vehicle. The vehicle may, for example, be designed as a motor vehicle and/or passenger car and/or at least partially automated/autonomous vehicle. The vehicle may have a vehicle device, for example, for providing an autonomous driving function and/or a driver assistance system. The vehicle device may be configured to control the vehicle at least partially automatically and/or to accelerate and/or brake and/or steer.

Another object of the disclosure is a computer program, in particular a computer program product, comprising instructions which, when the computer program is executed by at least one computer, prompt the computer to carry out the method according to the disclosure. The computer program according to the disclosure thus brings about the same advantages as have been described in detail with reference to the method according to the disclosure.

The subject matter of the disclosure is also a device for data processing that is configured to execute the method according to the disclosure. The device can be at least one computer, for example, that executes the computer program according to the disclosure. The computer may have at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or instructions that, when executed by at least one computer, prompt said computer program to carry out the method according to the disclosure. The storage medium is configured, for example, as a data memory such as a hard disk and/or a non-volatile memory and/or a memory card. The storage medium may, for example, be integrated in the computer.

Furthermore, the method according to the disclosure may also be executed as a computer-implemented method. Alternatively or additionally, at least one of the disclosed method steps may be computer-implemented and/or performed automatically.

### BRIEF DESCRIPTION OF THE DRAWINGS

Further advantages, features and details of the disclosure will be apparent from the following description, in which exemplary embodiments of the disclosure are described in detail with reference to the drawings. In this case, the features mentioned in the claims and in the description may in each case be essential to the disclosure individually or in any desired combination. The following is shown in the figures below:

FIG. 1 a schematic visualization of a method, a device, a storage medium, and a computer program according to exemplary embodiments of the disclosure,

FIG. 2 a schematic representation of a free space according to exemplary embodiments of the disclosure.

FIG. 3 a schematic representation of a first architecture for the method according to the disclosure according to exemplary embodiments of the disclosure.

FIG. 4 a schematic representation of a second architecture for the method according to exemplary embodiments of the disclosure.

### DETAILED DESCRIPTION

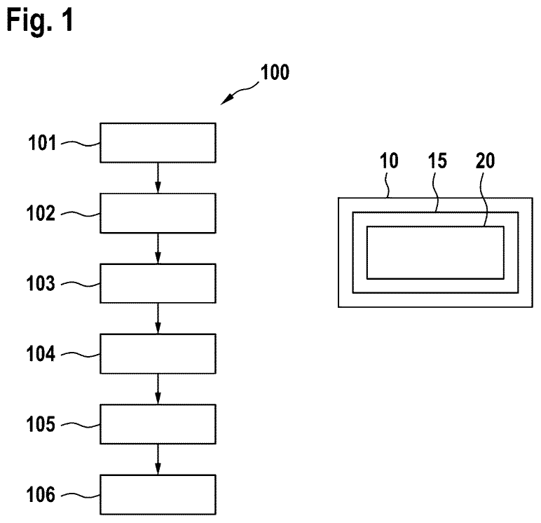

FIG. 1 schematically illustrates a method 100, a device 10, a storage medium 15, and a computer program 20 according to exemplary embodiments of the disclosure.

FIG. 1 shows, in particular, an exemplary embodiment of a method 100 for providing a representation of a free space in an environment of a technical system 1. In a first step 101, sensor data is provided, wherein the sensor data results from a detection by at least one sensor 221 of the technical system 1. In a second step 102, features are extracted from the sensor data to provide a feature map of the environment of the technical system 1. In a third step 103, virtual beams are projected into the provided sensor data, wherein a common origin starting from the technical system 1 and a respective beam direction are specified for the virtual beams to be projected. In a fourth step 104, individual positions along the projected virtual beams are scanned, wherein extracted features of the provided feature map are determined at each of the scanned individual positions. In a fifth step 105, a length value is determined for each projected virtual beam based on a result of the scan 104. In a sixth step 106, the representation of the free space is provided on the basis of the specified common origin, the specified beam direction, and the determined length values of the projected virtual beams.

When predicting navigable surfaces using a prior art approach, memory and computing requirements in particular scale quadratically with the size of the cells in the bird's-eye view. Therefore, high resolution requirements make it particularly difficult to calculate these approaches in embedded environments with real-time requirements. The method according to the disclosure, on the other hand, does not scale directly with increased resolution requirements, as it is decoupled from the feature space of the bird's-eye view representation and does not place any direct resolution requirements on the features of the bird's-eye view representation. Depending on the requirements for angular resolution, the approach according to the disclosure scales only linearly with higher angular resolution. This enables, for example, the use of high-resolution free-space detectors on embedded hardware.

Furthermore, according to exemplary embodiments of the disclosure, the method can also be carried out without coded features in the bird's-eye view, which is not possible with other approaches according to the prior art. This enables integration with approaches for sparse 3D object detection, for example.

The disclosure is widely applicable in various scenarios in which the environment of a technical system 1 (e.g., an (ego) vehicle) must be efficiently perceived. This can include general occupancy detection, detection of drivable surfaces, detection of obstacles or objects, obstacle avoidance in robotics, and much more.

Specific areas that can benefit from this disclosure include, for example, the mobility sector, particularly for advanced driver assistance systems (ADAS), where perception of a static environment around the vehicle is critical for downstream tasks such as route planning and driving.

The disclosure can be used to analyze data originating from a sensor. The sensor can determine measurements of the environment in the form of sensor signals, which can be provided, for example, by digital images such as video, radar, LiDAR, ultrasound, motion, and thermal imaging.

The disclosure can be used to classify sensor data, detect the presence of objects in sensor data, or perform semantic segmentation of sensor data, e.g., with respect to drivable surfaces, occupied areas, dynamic objects, and/or elevated structures.

The disclosure can be used to determine one continuous value or several continuous values, i.e., to perform a regression analysis, e.g., with respect to a distance.

The disclosure relates in particular to mapping occupancy grids, where one objective may be to predict the distribution of free and occupied space around an agent, in particular a technical system 1 such as a vehicle, preferably including a prediction of general semantics such as drivable surfaces. The resulting prediction of the occupied space can be used for further downstream tasks. For example, in the context of at least partially automated driving, a (trajectory) planner can use the representation of free space according to the disclosure to plan an optimal trajectory through the scene. The representation of free space according to the disclosure can also be used for cross-validation or extension of other outputs, such as 3D bounding boxes.

The method according to exemplary embodiments of the disclosure combines, in particular, new and existing machine learning techniques with new ideas in a new context in order to combine various advantages. The method according to exemplary embodiments of the disclosure uses, for example, transformer architectures, self-attention, and/or cross-attention. The concept of transformer architecture includes, in particular, queries, keys, and values. Knowledge can be aggregated through queries by interacting with keys and values. When queries, keys, and values originate from the same set of features, this can be referred to as self-awareness. If they come from different sets of features, this can be referred to as cross-attention. Self-attention blocks can be used to refine queries, while cross-attention blocks enable knowledge transfer from other feature sets into the queries. When multiple self-attention and optional cross-attention blocks are combined, this can be referred to as a transformer network or a transformer architecture. In particular, the runtime of a transformer architecture scales only with the number of queries and keys.

One possible extension for cross-attention in computer vision, for example, is to allow a small number of queries, specifically a fixed number, to take into account features within a feature grid by assigning positions to queries (fixed or predicted) and bilinearly scanning keys and values from the feature grid. In particular, queries can be assigned continuous positions, while the feature grid can be discretized with an independent resolution.

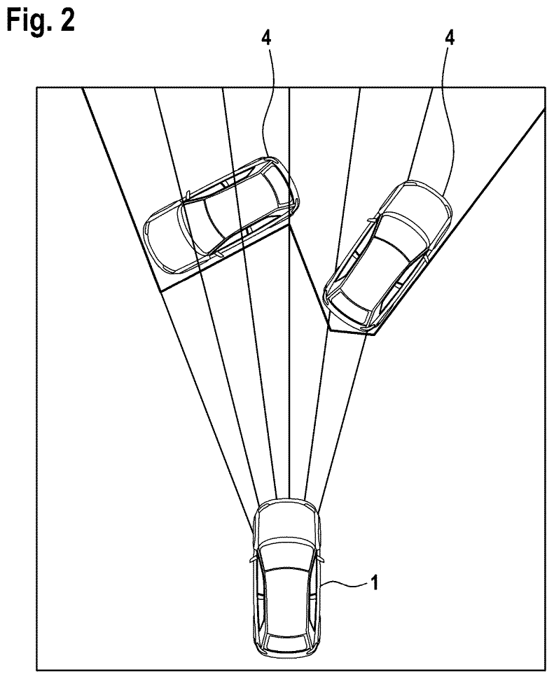

Another concept that can be used in the method according to the disclosure is the possibility of approximating a polygon with a set of virtual beams. All virtual beams preferably have a common origin. Each virtual beam is preferably assigned a beam direction and a length value. This results in a two-dimensional or three-dimensional position and can represent a vertex of a polygon. Such a polygon can be used to approximate a surface, e.g., a free surface (with limitations). The length of these virtual beams can be selected so that the resulting polygon does not overlap with the target, in this case, for example, the occupied area. Furthermore, it can be optimized to come close to the actual target. An example of such a polygon can be seen in FIG. 2, where an ego vehicle is represented as technical system 1 and two other vehicles are represented as objects 4, which delimit a free space around the ego vehicle 1. Such polygons can be used to efficiently describe areas, e.g., drivable surfaces in the context of automated driving for use in downstream tasks such as a (trajectory) planner. A possible bird's-eye view architecture could be used for predicting a dense free space estimate. In a post-processing step, a polygon can be approximated to create a sparse representation from the dense coverage.

According to exemplary embodiments of the disclosure, a machine learning model is provided that can predict the representation of free space in the form of a sparsely populated polygon, rather than making a dense prediction based on a bird's-eye view representation, which requires high resolution. This allows the resolution of the bird's-eye view to be reduced without compromising the accuracy of the output display, since the resulting polygon is not directly linked to the resolution of the bird's-eye view.

In order to train a machine learning model according to the disclosure, a correct fundamental truth is particularly necessary. This can be achieved by using an existing dense free space fundamental truth pipeline. In other words, the fundamental truth may include reference data representing a free space and objects around a vehicle, so that the machine learning model can learn to predict the free space based on this reference data. The fundamental truth can be reworked like an output of a dense bird's-eye view predictor. Common methods for adjusting such a polygon approximation can be used. Since this step only needs to be performed during training, more computationally intensive optimizations can be used to create accurate polygons.

The method according to exemplary embodiments of the disclosure can be implemented both based on a bird's-eye view representation and without it, whereby the method can be applied flexibly to existing architectures in particular.

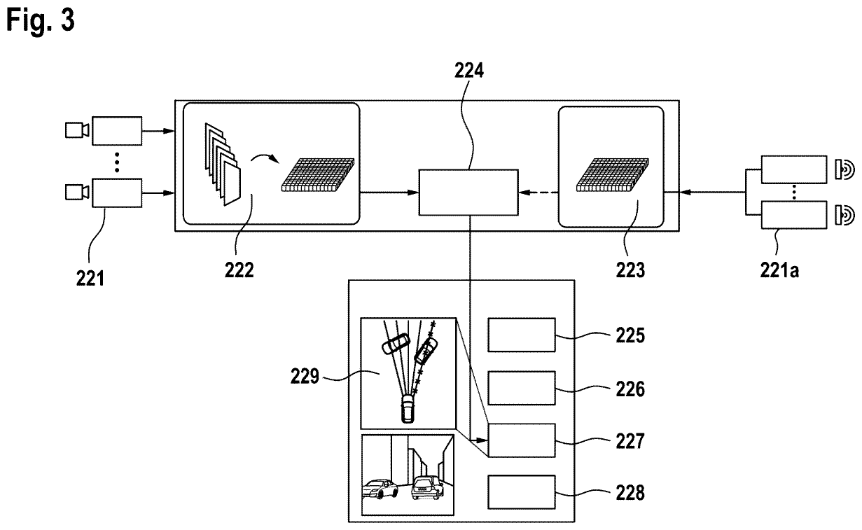

An exemplary embodiment of an initial architecture for the method according to the disclosure in connection with prediction based on the bird's-eye view is shown in FIG. 3.

Based on sensor data collected from various sensors 221, in particular a multi-view camera system, features are preferably extracted from the sensor data in accordance with step 222 using at least one machine learning model and converted into a bird's-eye view representation. Optionally, these features can be merged with additional features from other sensors 221a, such as radar, lidar, and/or ultrasonic sensors, in accordance with step 224. The other features can also be transferred to the bird's-eye view in accordance with step 223.

According to step 225, virtual beams can now be cast in all relevant directions using a predefined scanning strategy. For example, scanning can be uniform or higher towards the front. These projected virtual beams are now preferably projected into the bird's-eye view, as shown in the adjacent illustration 229, in accordance with step 226. Then, preferably in accordance with step 227, multiple positions on the respective projected virtual beams are scanned and used to obtain features from the feature map of the bird's-eye view 224. In particular, it may be provided that the feature map of the bird's-eye view representation learns a continuous embedding space from which scanning can be performed at arbitrary positions.

The scanned features can then be encoded into beam features and processed together with neighboring beam features by the machine learning model or another machine learning model. After that, a length value can be predicted for each virtual beam in accordance with step 228. In addition, additional properties such as height and/or semantic classes can be predicted. For step 228, multilayer perceptrons (MLP), convolutional neural networks (CNN), or transformer-based approaches can be used, for example.

Finally, the predicted length values and the predefined beam directions can be combined to obtain points in the environment of the technical system that can be used as corner points for the resulting polygon. A respective edge between two corner points defines, in particular, a boundary of the free space.

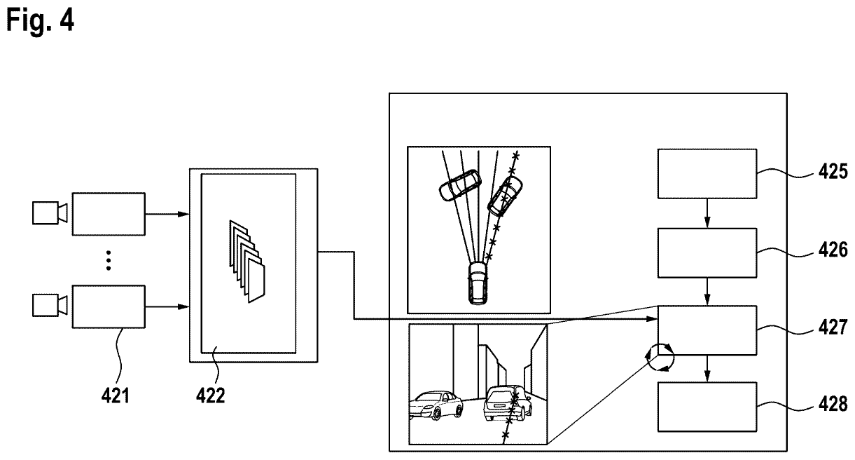

An exemplary embodiment of a second architecture for the method without the bird's-eye view is shown in FIG. 4 and is similar to the architecture described above, with some changes in particular in the area of sampling along the virtual beams and the extracted features. This allows an alternative solution to be provided. Initially, sensors 421 may be identical to sensors 221 and the same sensor data may be recorded. In the next step 422, features are also extracted from the sensor data, but the extracted features are not transformed into a bird's-eye view space. In accordance with step 425, analogous to step 225, virtual beams will be projected in all relevant directions using a predefined scanning strategy. The virtual beams are now projected into the sensor data in accordance with step 426, and in step 427, preferably several features, for example randomly, are scanned from the projected virtual beams. This process can be repeated several times to account for different heights of the virtual beams, which affect the projection on the sensor data. The final prediction of the virtual beams according to step 428 and the output processing are preferably performed in the same manner as for the approach described above with reference to FIG. 3, which is based on the bird's-eye view representation. The advantage of the approach without the bird's-eye view representation is, in particular, that it does not require a bird's-eye view representation and therefore offers some advantages in reducing the computational effort, especially when larger distances of free space are represented in the sensor data.

The foregoing explanation of the exemplary embodiments describes the present disclosure exclusively in the context of examples. Of course, individual features of the exemplary embodiments may, where technically sensible, be combined freely with one another without departing from the scope of the present disclosure.

What is claimed is:

1. A method for providing a representation of a free space in an environment of an engineering system, comprising:
providing sensor data, wherein the sensor data results from a detection of at least one sensor of the technical system;
extracting features from the sensor data to provide a feature map of the environment of the technical system;
projecting virtual beams into the provided sensor data, wherein a common origin starting from the technical system and a respective beam direction are specified for the virtual beams to be projected;
scanning individual positions along the projected virtual beams, wherein extracted features of the provided feature map are determined at each of the scanned individual positions;
determining a length value for each projected virtual beam based on a result of the scanning; and
providing the representation of the free space based on the specified common origin, the specified beam direction, and the determined length values of the projected virtual beams.

2. The method according to claim 1, further comprising transferring the provided sensor data into a bird's-eye view representation, wherein:
in the context of projection, the virtual beams are projected into the bird's-eye view representation.

3. The method according to claim 1, further comprising:
providing further sensor data, wherein the further sensor data results from a detection of at least one further sensor of the technical system, wherein the at least one further sensor corresponds to a different sensor modality than the at least one sensor;
extracting features from the additional sensor data; and
merging the extracted features from the additional sensor data with the extracted features from the sensor data to provide the feature map of the environment of the technical system.

4. The method according to claim 1, wherein the scanning of the individual positions is performed at uniform and/or random intervals and/or at intervals determined within the framework of machine learning along the virtual beams.

5. The method according to claim 1, further comprising predicting a height and/or semantic class of objects in the environment of the technical system based on the provided feature map, wherein:
in the context of the representation of the free space, the predicted height and/or the semantic class of the objects in the environment of the technical system is also specified.

6. The method according to claim 1, wherein:
the representation of the free space represents the free space in the form of a polygon, and
corner points of the polygon correspond to end points of the projected virtual beams.

7. The method according to claim 1, wherein the technical system is a vehicle or a mobile robot.

8. A computer program comprising instructions which, when the computer program is executed by at least one computer, prompt the computer to execute the method according to claim 1.

9. A device for data processing that is configured to execute the method according to claim 1.

10. A computer-readable storage medium comprising instructions which, when executed by at least one computer, prompt the computer to perform the method according to claim 1.
